(19) United States
(12) Patent Application Publication
(10) Pub. No.: US 2010/0122224 A1
(43) Pub. Date: May 13, 2010

(54) METHOD AND APPARATUS FOR DESIGNING AN INTEGRATED CIRCUIT

(75) Inventors: Kevin Lucas, Meylan (FR); Robert Boone, Austin, TX (US); Christian Gardin, Lancey (FR)

Correspondence Address: LARSON NEWMAN & ABEL, LLP, 5914 WEST COURTYARD DRIVE, SUITE 200, AUSTIN, TX, 78730, US

(73) Assignee: Freescale Semiconductor, Inc., Austin, TX (US)

(21) Appl. No.: 12/597,034

(22) PCT Filed: May 3, 2007
(86) PCT No.: PCT/IB07/52708

§ 371 Date: Oct. 22, 2009

(51) Int. Cl. G06F 17/50; G06G 7/62

(52) U.S. Cl. 716/4; 703/14

(57) ABSTRACT

Method and apparatus for designing an integrated circuit by providing an IC layout design. Adding one or more assist features to the IC layout design. Identifying which of the one or more added assist features in the IC layout design will cause one or more defects in the resultant wafer die manufactured from the IC layout design. Amending the one or more identified assist features.

### FIELD OF THE INVENTION

The present invention relates to a method and apparatus for designing an integrated circuit.

### BACKGROUND OF THE INVENTION

When making an integrated circuit (which may also be referred to as an IC, chip or device), a design layout of the IC is made using, for example, CAD tools. A reticle or mask is then produced for the IC design layout and then photolithography is used to transfer features from the reticle or mask to a die (integrated circuit semiconductor wafer).

Various techniques are used to reduce the level of defects in the resultant die. For instance, prior to the production of the reticle, the design layout may be optimised using optical proximity correction (OPC) to create a reticle layout. This optimisation process amends the physical design layout in order to avoid optical or process distortions also known as patterning defects when features are transferred from the reticle or mask that may cause failures of the device.

Assist features may be added to an IC layout design to reduce optical distortions. Preferably, assist features should not be printed on the resultant die and so usually assist features are small when compared to the required feature of an IC layout design.

Furthermore, a cautionary approach to assist features is usually taken with fewer being included in an IC layout design rather than risking the printing of the assist features on the resultant wafer die. Although this cautionary approach leads to fewer assist features being printed on the reticle or mask other defects may remain uncorrected that may have benefited from one or more additional assist features.

### SUMMARY OF THE INVENTION

The present invention provides a method and apparatus for designing an integrated circuit as described in the accompanying claims.

### BRIEF DESCRIPTION OF THE FIGURES

The present invention may be put into practice in a number of ways and an embodiment will now be described by way of example only and with reference to the accompanying drawings, in which:

FIG. 1 shows a SEM image of a portion of a wafer die including a defect;

FIG. 2 shows a schematic diagram of a portion of an IC layout design corresponding to the area shown in FIG. 1;

FIG. 3 shows a schematic diagram of a feature within an IC layout design including an assist feature;

FIG. 4 shows schematic diagram of the feature of FIG. 3 with an amended assist feature; and

FIG. 5 shows a flowchart of a method for designing an integrated circuit according to an embodiment of the present invention, given by way of example.

It should be noted that the figures are illustrated for simplicity and are not necessarily drawn to scale.

### DETAILED DESCRIPTION OF AN EMBODIMENT

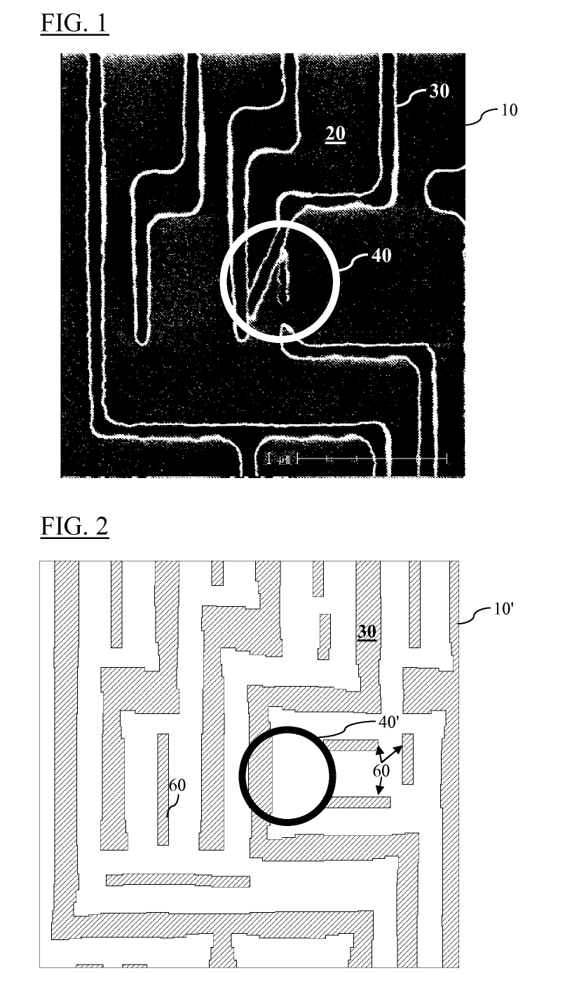

FIGS. 1 and 2 shall now be used to illustrate how one example optical defect develops and how assist features may be used to avoid these types of defects.

FIG. 1 shows an SEM of a portion of a wafer die 10. The wafer die was manufactured with the reticle deliberately defocused to cause a defect. Features 30 are formed on substrate 20 of the wafer die 10 and represent features of an IC. Circle 40 highlights an area on the wafer die 10 containing a defect. This defect results in a break in one track and a short circuit to another track.

FIG. 2 shows a schematic diagram of an IC layout design 10′ corresponding to the area shown in FIG. 1. Similar features have been given the same reference numerals.

Assist features 60 are shown within the IC layout design 10′. Circle 40′ highlights an area on the IC layout design 10′ that does not contain an assist feature and which therefore led to the defect in FIG. 1. The addition of an assist feature within this circle 40′ should correct the defect shown in FIG. 1 by changing the optical response of the reticle used to produce the wafer die.

FIGS. 1 and 2 highlight the importance of assist features in avoiding defects caused by diffraction and other optical or etching effects.

Assist features may be applied to an IC layout design using a set of rules. The more aggressive the rules, the more assist features are included leading to fewer optical or etching defects forming in the resultant die. However, with more aggressive rules a higher number of assist features may be printed in the resultant wafer die. Printed assist features are themselves defects as they may lead to short circuits or to other electrical failures in the IC circuit.

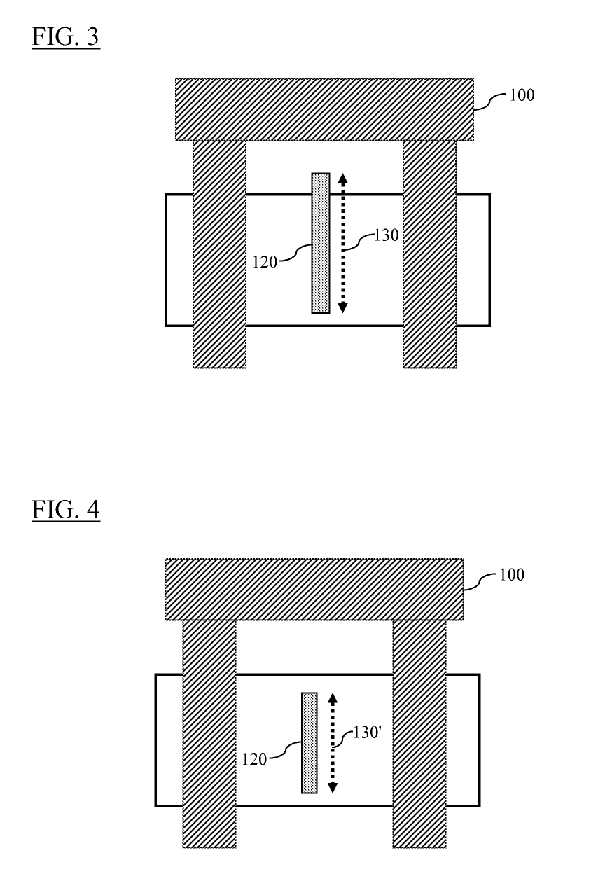

FIGS. 3 and 4 shall now be used to describe how printed assist features may be modified so that they no longer print.

FIG. 3 shows a schematic diagram of an example feature, a single gate 100, within an IC layout design. Assist feature 120 is present to ensure that the features of the gate 100 are formed correctly on a resultant wafer die. The length of assist feature 120 is indicated by arrow 130. An optical and/or resist optimisation or simulation technique may be used to check if assist feature 120 will be printed on a resultant wafer die. Should this optimisation or simulation predict that assist feature 120 will be printed this assist feature may be modified in a number of ways in order to avoid or reduce the likelihood of such printing. It may be a goal of the optimisation process to minimise such printed defects. The optimisation or simulation may be performed as part of an OPC process or separate to it (before or after).

FIG. 4 shows the same gate 100 as FIG. 3 but assist feature 120 has been shortened as shown by arrow 130′. This shortening reduces the probability of the assist feature 120 being printed.

Other amendments may be made to assist features to avoid them being printed and include moving the assist feature closer or further away from the feature being corrected (in FIGS. 3 and 4 the feature is a gate 100 but other features may be used) or reduced in size. Alternatively, the assist features found to be printed in simulation may be deleted from the IC layout design. Other amendments to assist features may also be used. The severity of the defect caused by a printed assist feature may be assessed with higher severity defects being corrected by total removal of the offending assist feature and lower severity defects leading to an amendment of the assist feature causing the defect.

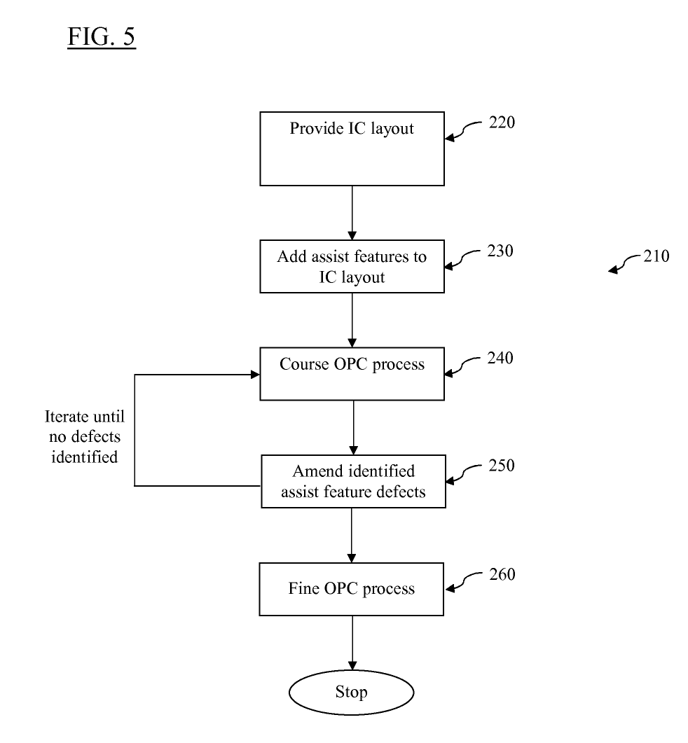

FIG. 5 shows a flowchart of a method 210 for designing an IC according to one aspect of the present invention. Method 210 does not contain all of the steps for designing an IC and the remaining steps will be familiar to the skilled person. The process starts with providing an IC layout design 220.

Next, assist features are added to the IC layout design 230. Assist features may be added using a rule based technique or other scheme. In particular, the assist features may be added aggressively, such that a proportion may be printed should the IC layout design be manufactured at this stage.

For instance, the size and shape of assist features may be limited by rules to prevent them from being printed. A more aggressive scheme may allow larger, for instance, longer or wider, assist features to be introduced. These larger assist features may be used to further improve the depth of focus achievable by a reticle. However, a proportion of these larger (or otherwise shaped) assist features may be printed on a resultant wafer die or cause other defects to arise.

The next step is to identify which of the one or more added assist features in the IC layout design will cause one or more defects in the resultant die manufactured from the IC layout design. In an embodiment of the invention, a coarse OPC process may be performed. Model or rule based OPC software may be used such as that supplied by Mentor Graphics® of Wilsonville, Oreg. USA or Synopsys, Inc. of Mountain View, Calif. USA, for instance. The OPC process need not be coarse but this minimises the required computer run-time. In any case, a full OPC process and/or simulation may not be required as the purpose of this step is to identify which assist features will be printed. The location or other identifier of printed assist features may also be stored during this step.

A coarse OPC process may involve a limited number or type of rules in a rule based process or a simple model in a model based simulation.

Next, the identified assist features (that may be printed) are modified or amended in step 250. Amendments may be made such that defect causing assist features no longer cause defects or reduces the likelihood or probability of defects to occur in a resultant IC wafer die. Amendments may be carried as described with reference to FIGS. 3 and 4 or other adjustments to the IC layout design may be made in order to suppress the printing of unwanted assist features or other defects. For instance, surrounding features may also be amended or moved.

Several iterations of steps 240 and 250 may occur until no further printing assist features are identified or the number of suspected assist features is reduced to an acceptable limit.

Next, a finer OPC process and/or simulation may be carried out as step 260. This fine OPC process may be used to find any remaining printing assist features or other defects in the IC layout design. The resultant IC layout design may be used to manufacture an IC wafer die in according to the usual methods. The fine OPC process may involve more complex or a higher number of rules than that of the coarse OPC process 240.

According to this method many more assist features may be added at step 230 than would be possible without them being filtered from the design as described above. Initially more assist features are added to the IC layout design and then problematic or possibly defective assist features are filtered out leaving more reliable assist features. This method therefore reduces the likelihood of optical defects occurring without causing assist features to be present in the final wafer die. In other words, a more aggressive set of rules may be used to place assist features within the IC layout design than could be used in prior art methods.

The method described above may be carried out in an automated manner using suitable apparatus or a computer programmed to perform each of the method steps. Suitable computer systems include PCs running a Windows® operating system or a UNIX based system such as a SPARC system running Solaris® by Sun Microsystems.

As will be appreciated by the skilled person, details of the above embodiment may be varied without departing from the scope of the present invention, as defined by the appended claims.

For example, identified assist features may be marked instead of or as well as being amended or deleted.

Step 240 uses a coarse OPC process to identify the printed assist features. However, other techniques may be used to identify or filter out these features.

Steps 240 and 250 may be combined so that the OPC process and/or simulation includes an optimisation process to amend any printed assist features to reduce the probability of them being printed on the resultant wafer die.

The coarse OPC step 240 may be model or rule based OPC.

Steps 240 and 250 may be iterated until a predetermined number, percentage or density of defects is reached rather than eliminating all defects such as printed assist features. This avoids an infinite loop should persistent defects occur.

1. A method for designing an integrated circuit, IC, comprising the steps of:
(a) providing an IC layout design; and
(b) adding one or more assist features to the IC layout design;
(c) identifying which of the one or more added assist features in the IC layout design will cause one or more defects in the resultant wafer die manufactured from the IC layout design; and
(d) amending the one or more assist features identified in step (c); and
(e) identifying any remaining defects using a fine OPC process, wherein the coarse OPC process comprises fewer rules or a simpler model than the fine OPC process.

2. (canceled)

3. (canceled)

4. The method according to claim 1, wherein step (c) further comprises simulating the IC layout design.

5. The method according to claim 2, wherein the simulation is an optical and/or resist simulation.

6. The method according to claim 1, wherein the one or more defects is a printed assist feature.

7. The method according to claim 1, wherein step (c) further comprises storing the location or locations of the identified one or more assist features.

8. The method according to claim 1, wherein step (c) further comprises identifying a neighbouring feature of the IC layout design to the identified one or more assist features.

9. The method according to claim 1, wherein step (d) further comprises moving an edge of the one or more identified assist features.

10. The method according to claim 1, wherein step (d) further comprises shortening the one or more identified assist features.

11. The method according to claim 1, wherein step (d) further comprises moving the one or more identified assist features.

12. The method according to claim 1, wherein step (d) further comprises deleting the one or more identified assist features.

13. The method according to claim 1, wherein step (b) further comprises adding assist features to the IC layout design such that one or more of the added assist features will cause a defect to be subsequently identified in step (c).

14. The method according to claim 1, wherein step (b) is performed to improve the depth of focus of the IC layout design.

15. The method according to claim 1, wherein the one or more assist features added in step (b) are added using a design rule.

16. The method according to claim 13, wherein the design rule allows a specific proportion of assist features to be printed on a resultant wafer die.

17. The method according to claim 1, wherein step (d) is performed such that the probability is reduced of the occurrence of the one or more defects in the resultant wafer die.

18. The method according to claim 1, wherein step (d) is performed such that the one or more defects is removed.

19. (canceled)

20. (canceled)

21. (canceled)

22. An integrated circuit manufactured according to the method comprising the steps of:
(a) providing an IC layout design;
(b) adding one or more assist features to the IC layout design;
(c) identifying which of the one or more added assist features in the IC layout design will cause one or more defects in the resultant wafer die manufactured from the IC layout design;
(d) amending the one or more assist features identified in step (c); and
(e) identifying any remaining defects using a fine OPC process, wherein the coarse OPC process comprises fewer rules or a simpler model than the fine OPC process.

23. Apparatus for designing an integrated circuit comprising:
means for providing an IC layout design; and
means for adding one or more assist features to the IC layout design;
means for identifying which of the one or more added assist features in the IC layout design will cause one or more defects in the resultant wafer die manufactured from the IC layout design using a coarse optical proximity correction, OPC, process;
means for amending the one or more identified assist features; and
means for identifying any remaining defects using a fine OPC process, wherein the coarse OPC process comprises fewer rules or a simpler model than the fine OPC process.

24. The integrated circuit according to claim 22, wherein the one or more defects is a printed assist feature.
